(19) United States
(12) Patent Application Publication
(10) Pub. No.: US 2025/0343358 A1
(43) Pub. Date: Nov. 6, 2025

(54) Frequency Selective Structures for Automotive Radar

(71) Applicant: Waymo LLC, Mountain View, CA (US)

(72) Inventors: Chan Ping Edwin Lim, Cupertino, CA (US); Philip Gay Ping Ma, Torrance, CA (US); Simon Verghese, Mountain View, CA (US)

(21) Appl. No.: 18/656,273

(22) Filed: May 6, 2024

(51) Int. Cl. H01Q 15/00; G01S 7/03; G01S 13/86; G01S 13/931; H01Q 1/32

(52) U.S. Cl. CPC H01Q 15/0013; G01S 7/032; G01S 13/865; G01S 13/931; H01Q 1/3233

(57) ABSTRACT

Example embodiments relate to frequency selective structures for automotive radar. A system may include a frequency selective structure that is coupled to a radome and configured to optimize a desired band-pass for specific performance by one or more antennas. The frequency selective structure may comprise arrays of micro-wires forming a plurality of intersections and one or more patches positioned at one or more intersections of the plurality of intersections. In some cases, at least one patch of the one or more patches may be positioned with an offset relative to a corresponding intersection of the one or more intersections and the frequency selective structure has a rotational angle with respect to an antenna polarization of the one or more antennas. The frequency selective structure may be connected to a current source that can modify the temperature of the structure to melt rain or snow off the radome.

### BACKGROUND

Advancements in computing, sensors, and other technologies have enabled some vehicles to navigate safely between locations autonomously, i.e., without requiring input from a human driver. By processing sensor measurements of the surrounding environment in real-time, an autonomous vehicle can transport passengers or objects (e.g., cargo) between locations while avoiding obstacles, obeying traffic requirements, anticipating movements of nearby agents, and performing other actions that are typically conducted by a driver. Shifting both decision-making and control of the vehicle over to vehicle systems can allow passengers to devote their attention to tasks other than driving.

Automotive radar is a type of sensor used in vehicles to detect and monitor the surrounding environment. Radar can be useful for advanced driver-assistance systems (ADAS) and autonomous driving applications, where radar data can help to detect other vehicles, pedestrians, and obstacles, and also provide information about their distance, speed, and direction. A radar includes a radiating surface with an antenna that emits radio waves, which bounce off objects in the environment and return to the antenna, where they are detected and analyzed to determine the characteristics of the objects. The antenna is often housed within a protective cover known as a radome, which is typically designed to be transparent to the radio waves. Although the radome provides protection to the antenna, rain, snow, or ice can accumulate on the radome in some environments and interfere with the radio waves, reducing the performance of the radar.

### SUMMARY

Example embodiments relate to frequency selective structures that can be used in front of a radiating surface to optimize antenna performance. A frequency selective structure may be positioned on a radar's radome and used to filter radio waves received by the radar's antennas while also having properties that can be used to help keep the radome clear from rain, snow, and ice.

In one aspect, an example radar system is described. The radar system includes a frequency selective structure positioned in front of a radiating surface having one or more antennas. The frequency selective structure comprises arrays of micro-wires forming a plurality of intersections and one or more patches positioned at one or more intersections of the plurality of intersections. At least one patch of the one or more patches is positioned with an offset relative to a corresponding intersection of the one or more intersections and the frequency selective structure has a rotational angle with respect to an antenna polarization of the one or more antennas.

In another aspect, an example system is described. The system includes a frequency selective structure that is coupled to a radome and configured to optimize a desired band-pass for specific performance by one or more antennas. The frequency selective structure comprises arrays of micro-wires forming a plurality of intersections and one or more patches positioned at one or more intersections of the plurality of intersections. At least one patch of the one or more patches is positioned with an offset relative to a corresponding intersection of the one or more intersections and the frequency selective structure has a rotational angle with respect to an antenna polarization of the one or more antennas.

In another aspect, an example method is provided. The method involves forming a frequency selective structure configured to optimize a desired band-pass for specific performance by one or more antennas. The frequency selective structure comprises arrays of micro-wires forming a plurality of intersections and one or more patches positioned at one or more intersections of the plurality of intersections. At least one patch of the one or more patches is positioned with an offset relative to a corresponding intersection of the one or more intersections. The frequency selective structure has a rotational angle with respect to an antenna polarization of the one or more antennas. The method further involves coupling the frequency selective structure to a radome such that the frequency selective structure is positioned in front of a radiating surface having the one or more antennas.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 is a functional block diagram illustrating a vehicle, according to example embodiments.

FIG. 2A is an illustration of a physical configuration of a vehicle, according to example embodiments.

FIG. 2B is an illustration of a physical configuration of a vehicle, according to example embodiments.

FIG. 2C is an illustration of a physical configuration of a vehicle, according to example embodiments.

FIG. 2D is an illustration of a physical configuration of a vehicle, according to example embodiments.

FIG. 2E is an illustration of a physical configuration of a vehicle, according to example embodiments.

FIG. 2F is an illustration of a physical configuration of a vehicle, according to example embodiments.

FIG. 2G is an illustration of a physical configuration of a vehicle, according to example embodiments.

FIG. 2H is an illustration of a physical configuration of a vehicle, according to example embodiments.

FIG. 2I is an illustration of a physical configuration of a vehicle, according to example embodiments.

FIG. 2J is an illustration of a field of view for various sensors, according to example embodiments.

FIG. 2K is an illustration of beam steering for a sensor, according to example embodiments.

FIG. 3 is a conceptual illustration of wireless communication between various computing systems related to an autonomous or semi-autonomous vehicle, according to example embodiments.

FIG. 4 is a block diagram of a system including a radar unit, according to example embodiments.

FIG. 5A is an illustration of a front view of a radar system that includes a frequency selective structure, according to example embodiments.

FIG. 5B is an illustration of a side view of the radar system shown in FIG. 5A, according to example embodiments.

FIG. 5C is an illustration showing the radar system with the frequency selective structure positioned at a different orientation, according to example embodiments.

FIG. 6 is a flowchart of a method for forming a system that uses a frequency selective structure, according to example embodiments.

FIG. 7 is a flowchart of a method for using a frequency selective structure to optimize radar operations, according to example embodiments.

### DETAILED DESCRIPTION

Example methods and systems are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the figures should not be viewed as limiting. It should be understood that other embodiments might include more or less of each element shown in a given figure. Additionally, some of the illustrated elements may be combined or omitted. Yet further, an example embodiment may include elements that are not illustrated in the figures.

The present disclosure relates to frequency selective structures that may be positioned in front of a radiating surface or antenna to optimize performance of radar or another type of emitter. An example frequency selective structure may include arrays of micro-wires and one or more patches positioned at one or more intersections of the micro-wires (among other potential locations where patches may be positioned on the frequency selective structure). In some examples, at least one patch of the one or more patches may be offset relative to a corresponding intersection of the one or more intersections of the micro-wires.

The frequency selective structure may also have a rotational angle with respect to an antenna polarization of the one or more antennas. The rotation of the structure with respect to the antenna polarization may impact the elevation patterns produced during signal transmission. In some cases, further reduction in elevation sidelobe can be achieved by finding the optimum rotation angle. This may result in improved performance of the radar system.

In some cases, the frequency selective structure may be applied to a surface of a radome. The radome, which may be a part of an automotive radar system, can serve as a protective enclosure for the one or more antennas. When applied to the radome, the frequency selective structure may be positioned in front of the radiating surface of the one or more antennas. The distance between the radiating surface and the frequency selective structure may differ within examples, which can depend on factors such as the relationship between the radome and the radiating surface and the desired performance for the antennas. In some cases, simulations, testing, and validation may be used to determine the optimal position and orientation between the frequency selective structure and the antennas. In some examples, the frequency selective structure is printed or etched onto a thin film and then attached to the radome with pressure sensitive adhesive.

Positioning the frequency selective structure in front of the radiating surface may allow the frequency selective structure to interact with the electromagnetic waves radiated by the antennas, thereby influencing the performance of the radar system. In particular, the frequency selective structure may be configured to optimize a desired band-pass for specific performance by the one or more antennas. The properties of the frequency selective structure may allow signals within a specified frequency range to pass through while attenuating or blocking signals outside that range. The frequency range allowed by a frequency selective structure may depend on the spacing between the micro-wires within the frequency selective structure. As such, the frequency selective structure may include low pass filter (LPF) structures that allows signals with a frequency lower than a selected cutoff frequency to pass through while reducing the amplitude of signals with frequencies higher than the cutoff frequency and high pass filter (HPF) structures that passes signals with a frequency higher than a particular cutoff frequency while attenuating signals with frequencies lower than the cutoff frequency. In some cases, the LPF structures may be slanted degree micro-wires located across a field of view of the one or more antennas and the HPF structures may correspond to the one or more patches. The arrangement of the LPF structure and HPF structures may influence how the frequency selective structure serves as the band-pass filter for specific performance by a radar.

In some examples, one or multiple patches may be positioned on the frequency selective structure at various locations. The patches can be used to add more metal to the structure without compromising the radar technology. In some cases, one or more patches can be positioned away from intersections of the micro-wires. The one or more patches may be of any polygonal shape, such as circular, rectangular, diamond, honeycomb, triangular, etc. The shape and dimensions of patches can affect the resonant frequencies of the frequency selective structure. In some examples, the patches can consist of multiple shapes, which may be randomly distributed or positioned according to a pattern. A computing system may perform simulations to determine distribution parameters for the patches. For instance, the simulations can be used to identify the quantity of patches, locations for the patches, sizes and shapes for the patches, and other features for the patches. In some examples, the simulations can factor the structure of the radiating surface.

In addition, the frequency selective structure may include various features, such as being super hydrophobic and containing heating elements. By being super hydrophobic, the frequency selective structure can help repel rain, hail, and snow off the surface of a radome. The frequency selective structure (or portions of the frequency selective structure) can also be made in a material or materials that enables the temperature of the structure to be changed, which may enable the frequency selective structure to be used to maintain a consistent temperature for the radar components to operate optimally. For instance, the frequency selective structure may be composed of a material selected from the group consisting of metal, alloy, dielectric, and semiconductor. In some cases, a system may increase the temperature of the frequency selective structures to melt rain and snow that falls onto the radome. For instance, the frequency selective structure may be connected to a current source, which can supply current to increase the temperature of the frequency selective structure. As such, the frequency selective structure may be configured to melt snow or rain off the radome when current is applied to the structure, thereby enabling the radar to operate effectively in adverse weather conditions. The frequency selective structure can be connected to different types of power sources, which can be used to adjust the temperature of the frequency selective structure to adapt performance of the radar to current environment conditions.

When the frequency selective structure is heated to melt snow or rain off the radome or otherwise help optimize performance of the antennas, the frequency selective structure is able to continue effectively filtering electromagnetic waves from the antennas. The frequency selective structure filters the signals based on their frequency and not their temperature. The filtering effect of the structure is determined by its physical structure, such as the shape, size, and arrangement of its conductive elements and the electrical properties of its materials. As such, the frequency selective structure can be used effectively across a range of different temperatures and within various environment conditions.

The frequency selective structure can also include one or more cosmetic features that can enhance the appearance of a radome. For instance, the frequency selective structure may connect to light emitting diodes or include other features that can enhance the appearance of the radome.

Automotive radar systems and other types of antenna systems employing one or more frequency selective structures described herein can improve antenna performance by fine-tuning the frequency response and minimizing signal interference. Additionally, integrated heating elements within the frequency selective structures may help prevent ice and snow buildup on the antennas, which otherwise could impair the functionality of the antennas. The incorporation of a super hydrophobic characteristic within a frequency selective structure may also further aid in repelling water and salt accumulation, maintaining the operational integrity of one or multiple antennas.

In some examples, a vehicle equipped with ADAS and/or autonomous driving capabilities may feature multiple radar units placed at strategic locations to provide a comprehensive view of the vehicle's surroundings. For instance, one or multiple radar units may be positioned on the front and rear bumpers, side mirrors, and/or other portions of the vehicle (e.g., the roof). Each radar unit may be shielded by a radome, which protects the radar's components from the elements while offering transparency for accurate signal transmission and reception. To optimize the performance of each radar unit, frequency selective structures may be integrated onto the radomes. In some cases, the design of the frequency selective structures for each radar unit can vary considerably and may depend on one or more factors, such as the specific antenna configurations, the size constraints of the radomes, and the desired operational characteristics of each radar unit. For example, a front-facing radar designed for long-range detection may require a frequency selective structure positioned at a particular rotational angle relative to the underlying antennas to reduce sidelobe interference and enhance target detection at a distance. Conversely, a rear bumper radar, which may be used for parking assistance, might use a frequency selective structure with a broader band-pass to capture a wider field of view for detecting nearby objects.

The variations in frequency selective structures across different radomes may also account for the environmental conditions each radar unit faces. Radars mounted at lower points on the vehicle, like the bumpers, might encounter more moisture and debris, which may necessitate a more robust super hydrophobic coating or enhanced heating characteristics to prevent snow and ice accumulation. In contrast, a radar on the roof of the vehicle may have a complex frequency selective structure tailored to a multi-directional antenna array, which may ensure 360-degree coverage for autonomous navigation. Each structure may be designed to meet the specific requirements of its radar unit in order to help the vehicle's radar system to operate with maximum efficiency and reliability under various conditions.

A vehicle computing system can manage the operation of frequency selective structures to ensure that radars and other sensors maintain their temperatures within an optimum range, while also possessing the capability to melt and dispel various forms of precipitation, such as rain, snow, ice, and sleet. When the system detects a drop in temperature or the presence of precipitation, the system may initiate a current or adjust the current through the frequency selective structures, which can cause the frequency selective structures to generate heat to prevent ice formation and to melt existing precipitation, thereby preserving the visibility and functionality of the sensors.

In some examples, the vehicle computing system may leverage the resonant properties of circuits incorporating the frequency selective structures to distinguish between different types of obstructions on the radomes. By monitoring the resonance frequencies of the circuits that include frequency selective structures, the system can differentiate between debris or bug splatter and precipitation. In particular, different materials can have distinct dielectric properties, which affect the resonance of the circuit in different ways. For instance, a layer of water or ice from precipitation may have a different impact on the circuit's resonance compared to a layer of bug splatter or other debris. Similarly, the resonant frequencies across different frequency selective structures can be compared by the computing system to determine when an individual radar (or different type of sensor) may be impaired by a non-weather element, such as debris or insect splatter.

Furthermore, the resonance of the circuit can serve as a diagnostic tool to detect when a radome may be iced over, a condition that can severely impact the performance of radars and/or other types of sensors. The vehicle computing system may continuously monitor the resonance frequency and, upon detecting a resonance shift that indicates ice buildup, can increase the current to the frequency selective structure to generate more heat to melt the ice and restore sensor performance. A vehicle computing system may use this proactive approach to help ensure that the vehicle's radars and other types of sensors using such frequency selective structures remain operational and provide reliable data for ADAS and autonomous driving systems, especially in cold and adverse weather conditions.

In some examples, one or multiple capacitive elements (e.g., capacitors) can be integrated into a frequency selective structure circuit and used to detect the resonant frequency by being part of a resonant (e.g., inductor-capacitor) circuit. For example, at resonance, the reactive impedance of inductive and capacitive element(s) may cancel each other out, which can lead to a peak in current or voltage across the circuit that depends on the configuration of the circuit. By monitoring the voltage across the capacitive element(s) or the current through the capacitive element(s), the resonant frequency can be detected based on the voltage or current value being at their maximum.

In some aspects, the capacitive element(s) can act as a separate sensor by being placed in proximity to the frequency selective circuit without direct electrical connection. In this configuration, the capacitive element(s) can detect changes in the electromagnetic field at the resonant frequency of the frequency selective circuit. As the frequency selective structure resonates at its characteristic frequency, the frequency selective structure can induce a current in a nearby circuit, which can be detected by measuring the voltage across the capacitive element(s). This allows the capacitive element(s) to sense the resonant frequency wirelessly, which can be particularly useful in applications where direct electrical connections are impractical or where isolation from the frequency selective structure is desired.

In other cases, the capacitive element(s) can be directly connected to a conductive mesh that is part of the frequency selective structure (e.g., connected via the micro-wires). The mesh may act as an inductive element, and together with the capacitive element(s), form an LC circuit that is tuned to the desired resonant frequency of the frequency selective structure. A chip or processor can process the signal from the LC circuit to determine the presence of the resonant frequency and can be designed to provide additional functionalities such as signal filtering, amplification, and digital processing for further analysis or communication with other systems. The choice between the configurations using a capacitor may depend on the specific requirements desired for the frequency selective structure, such as sensitivity, form factor, and the level of integration with other electronic components.

The following description and accompanying drawings will elucidate features of various example embodiments. The embodiments provided are by way of example, and are not intended to be limiting. As such, the dimensions of the drawings are not necessarily to scale.

Example systems within the scope of the present disclosure will now be described in greater detail. An example system may be implemented on or may take the form of an automobile. Additionally, an example system may also be implemented on or take the form of various vehicles, such as cars, trucks (e.g., pickup trucks, vans, tractors, and tractor trailers), motorcycles, buses, airplanes, helicopters, drones, lawn mowers, earth movers, boats, submarines, all-terrain vehicles, snowmobiles, aircraft, recreational vehicles, amusement park vehicles, farm equipment or vehicles, construction equipment or vehicles, warehouse equipment or vehicles, factory equipment or vehicles, trams, golf carts, trains, trolleys, sidewalk delivery vehicles, and robot devices. Other vehicles are possible as well. Further, in some embodiments, example systems might not include a vehicle.

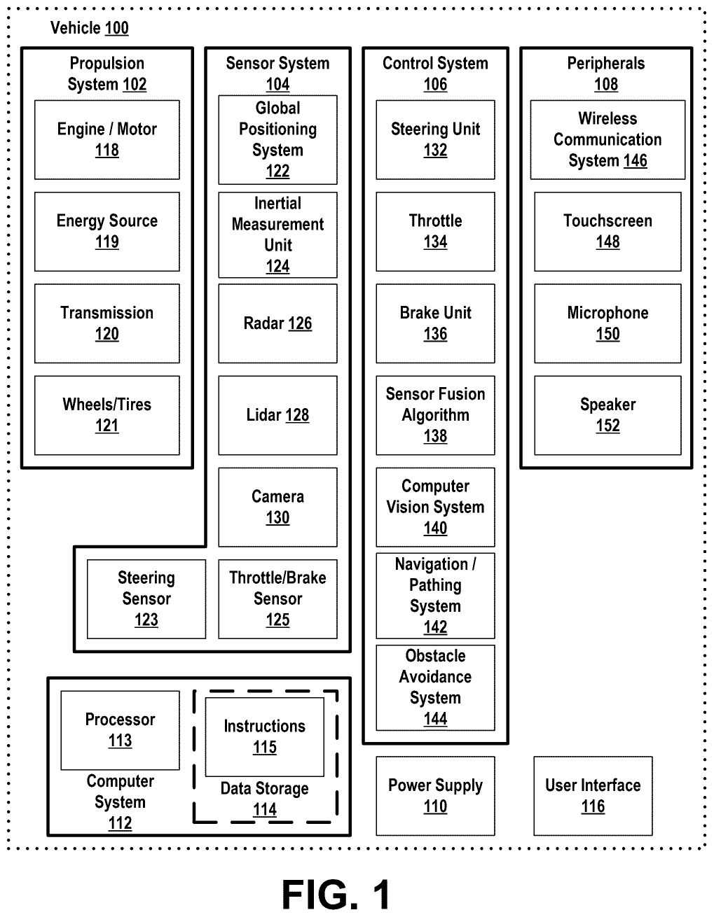

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. Additionally, vehicle 100 may operate in a partially autonomous (i.e., semi-autonomous) mode in which some functions of the vehicle 100 are controlled by a human driver of the vehicle 100 and some functions of the vehicle 100 are controlled by the computing system. For example, vehicle 100 may also include subsystems that enable the driver to control operations of vehicle 100 such as steering, acceleration, and braking, while the computing system performs assistive functions such as lane-departure warnings/lane-keeping assist or adaptive cruise control based on other objects (e.g., vehicles) in the surrounding environment.

As described herein, in a partially autonomous driving mode, even though the vehicle assists with one or more driving operations (e.g., steering, braking and/or accelerating to perform lane centering, adaptive cruise control, advanced driver assistance systems (ADAS), and emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods are described below in conjunction with autonomous vehicles, these or similar systems and methods can be used in various driver assistance systems that do not rise to the level of fully autonomous driving systems (i.e. partially autonomous driving systems). In the United States, the Society of Automotive Engineers (SAE) have defined different levels of automated driving operations to indicate how much, or how little, a vehicle controls the driving, although different organizations, in the United States or in other countries, may categorize the levels differently. More specifically, the disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

As shown in FIG. 1, vehicle 100 may include various subsystems, such as propulsion system 102, sensor system 104, control system 106, one or more peripherals 108, power supply 110, computer system 112 (which could also be referred to as a computing system) with data storage 114, and user interface 116. In other examples, vehicle 100 may include more or fewer subsystems, which can each include multiple elements. The subsystems and components of vehicle 100 may be interconnected in various ways. In addition, functions of vehicle 100 described herein can be divided into additional functional or physical components, or combined into fewer functional or physical components within embodiments. For instance, the control system 106 and the computer system 112 may be combined into a single system that operates the vehicle 100 in accordance with various operations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some embodiments, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some embodiments, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example embodiments. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, lidar 128, camera 130, steering sensor 123, and throttle/brake sensor 125, among other possible sensors. In some embodiments, sensor system 104 may also include sensors configured to monitor internal systems of the vehicle 100 (e.g., O₂ monitor, fuel gauge, engine oil temperature, and brake wear).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the surrounding environment of vehicle 100. As such, radar 126 may include antennas configured to transmit and receive radio signals. In some embodiments, radar 126 may correspond to a mountable radar configured to obtain measurements of the surrounding environment of vehicle 100.

Lidar 128 may include one or more laser sources, a laser scanner, and one or more detectors, among other system components, and may operate in a coherent mode (e.g., using heterodyne detection) or in an incoherent detection mode (i.e., time-of-flight mode). In some embodiments, the one or more detectors of the lidar 128 may include one or more photodetectors, which may be especially sensitive detectors (e.g., avalanche photodiodes). In some examples, such photodetectors may be capable of detecting single photons (e.g., single-photon avalanche diodes (SPADs)). Further, such photodetectors can be arranged (e.g., through an electrical connection in series) into an array (e.g., as in a silicon photomultiplier (SiPM)). In some examples, the one or more photodetectors are Geiger-mode operated devices and the lidar includes subcomponents designed for such Geiger-mode operation.

Camera 130 may include one or more devices (e.g., still camera, video camera, a thermal imaging camera, a stereo camera, and a night vision camera) configured to capture images of the surrounding environment of vehicle 100.

Steering sensor 123 may sense a steering angle of vehicle 100, which may involve measuring an angle of the steering wheel or measuring an electrical signal representative of the angle of the steering wheel. In some embodiments, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve and a carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in the navigation of vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some embodiments, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some embodiments, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software (e.g., a general purpose processor such as a central processing unit (CPU), a specialized processor such as a graphical processing unit (GPU) or a tensor processing unit (TPU), an application-specific integrated circuit (ASIC), a field programmable gate array (FPGA), a volatile memory, a non-volatile memory, or one or more machine-learned models) operable to process and analyze images in an effort to determine objects that are in motion (e.g., other vehicles, pedestrians, bicyclists, or animals) and objects that are not in motion (e.g., traffic lights, roadway boundaries, speedbumps, or potholes). As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, microphone 150 (e.g., one or more interior and/or exterior microphones), and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as code-division multiple access (CDMA), evolution-data optimized (EVDO), global system for mobile communications (GSM)/general packet radio service (GPRS), or cellular communication, such as 4G worldwide interoperability for microwave access (WiMAX) or long-term evolution (LTE), or 5G. Alternatively, wireless communication system 146 may communicate with a wireless local area network (WLAN) using WIFI® or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some embodiments. For instance, power supply 110 may include one or more batteries configured to provide electrical power. Vehicle 100 may also use other types of power supplies. In an example embodiment, power supply 110 and energy source 119 may be integrated into a single energy source.

Vehicle 100 may also include computer system 112 to perform operations, such as operations described therein. As such, computer system 112 may include processor 113 (which could include at least one microprocessor) operable to execute instructions 115 stored in a non-transitory, computer-readable medium, such as data storage 114. As such, processor 113 can represent one or multiple processors. In some embodiments, computer system 112 may represent a plurality of computing devices that may serve to control individual components or subsystems of vehicle 100 in a distributed fashion.

In some embodiments, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, or control system 106), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of a surrounding environment of vehicle 100 operating in an autonomous or semi-autonomous mode. The state of the surrounding environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar 126 and/or lidar 128, and/or some other environmental mapping, ranging, and/or positioning sensor system may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100 (i.e., wireless communication system 146, computer system 112, data storage 114, and user interface 116) as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

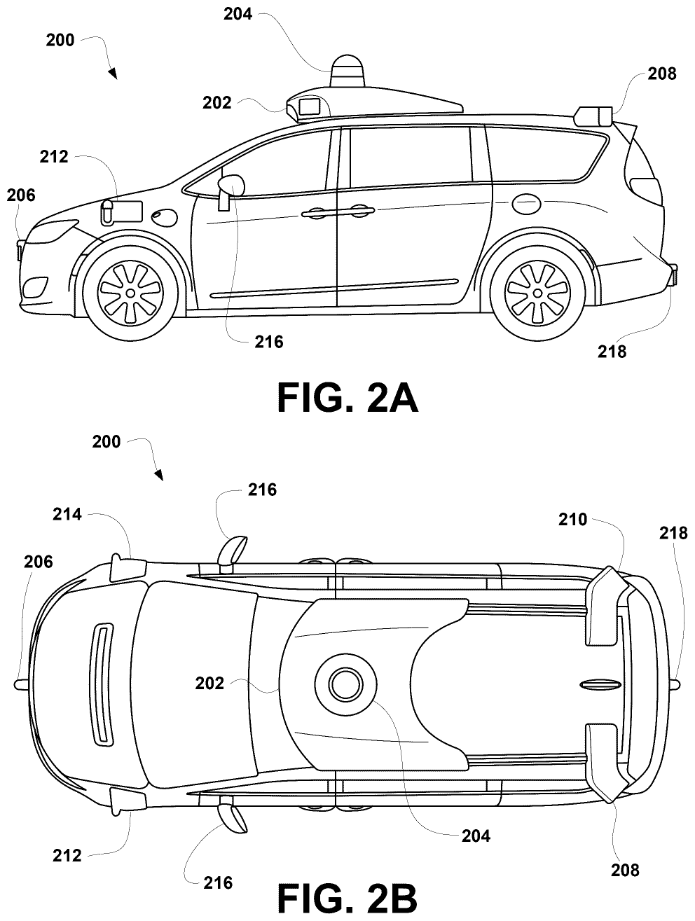

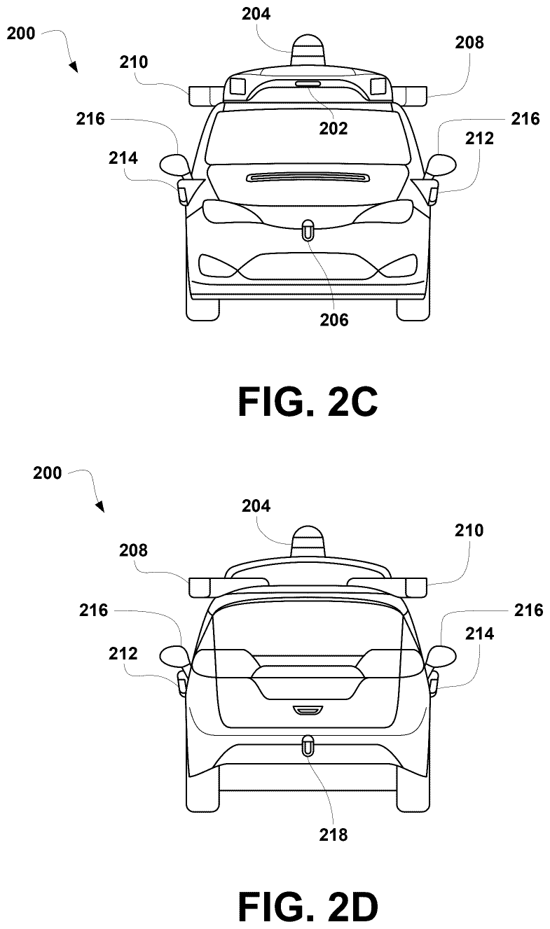

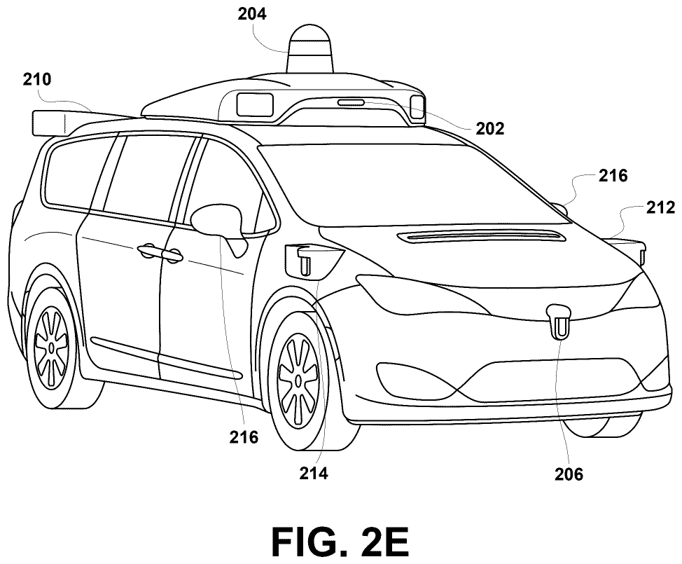

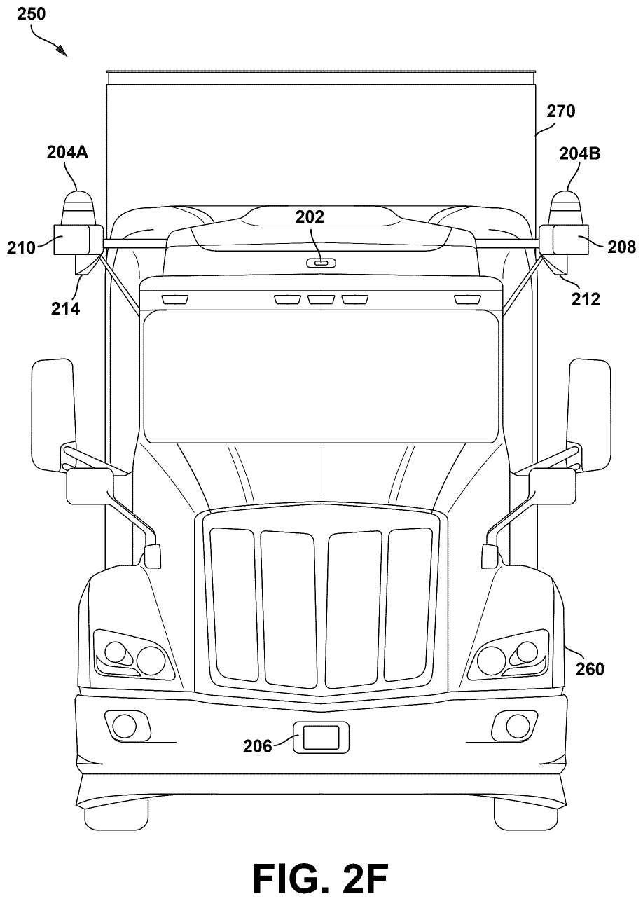

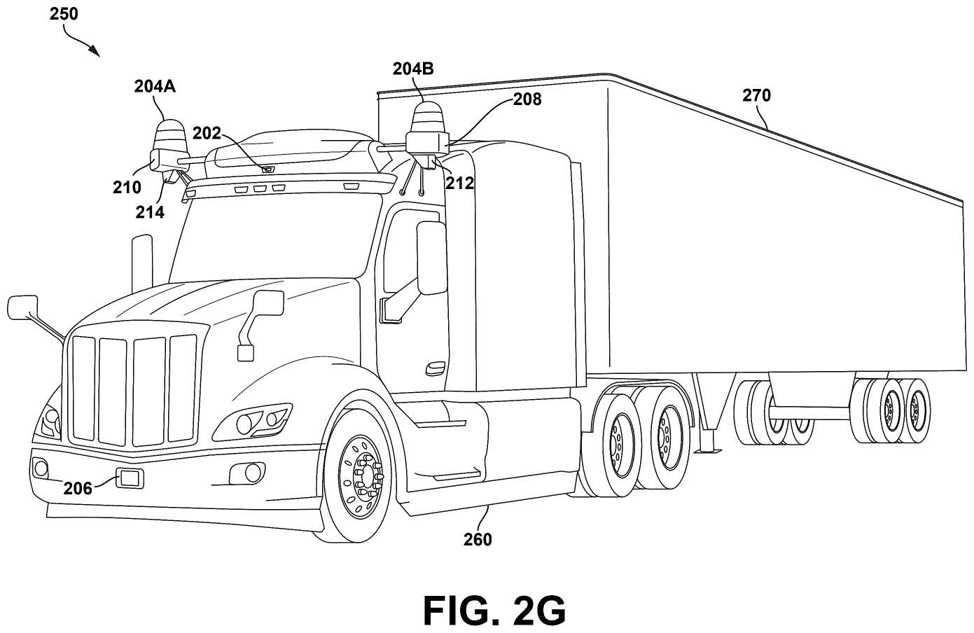

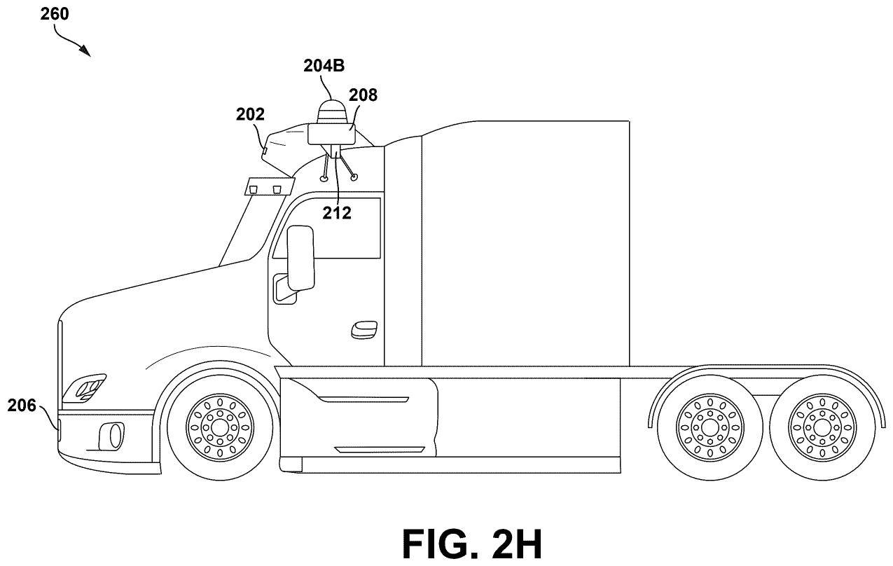

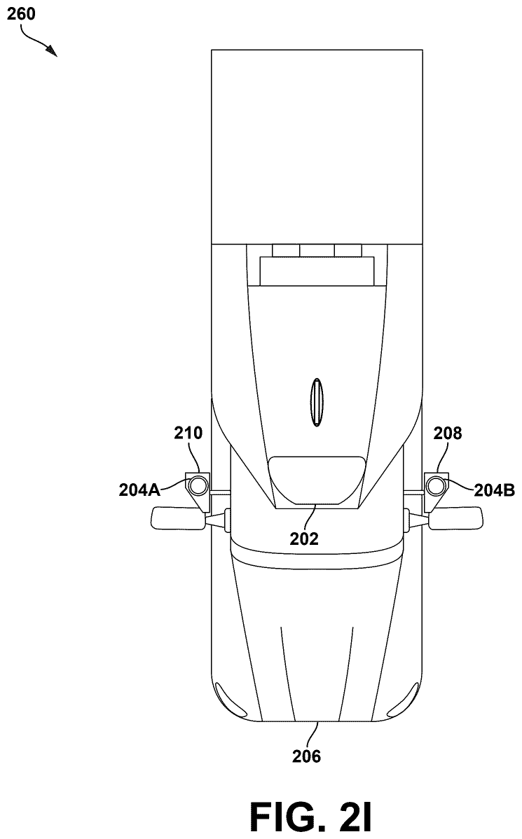

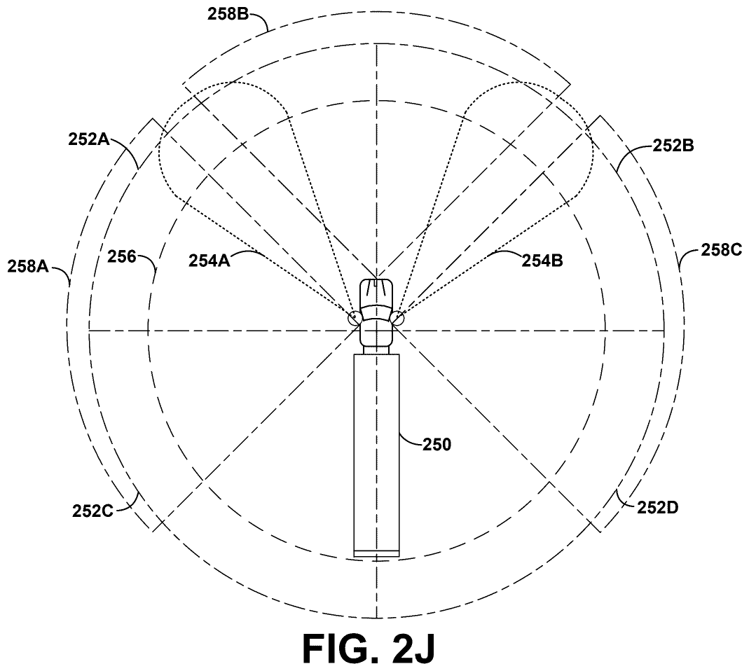

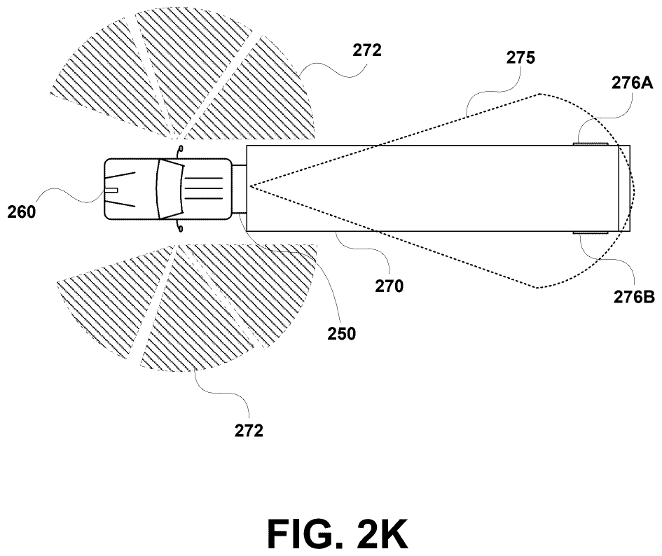

FIGS. 2A-2E show an example vehicle 200 (e.g., a fully autonomous vehicle or semi-autonomous vehicle) that can include some or all of the functions described in connection with vehicle 100 in reference to FIG. 1. Although vehicle 200 is illustrated in FIGS. 2A-2E as a van with side view mirrors for illustrative purposes, the present disclosure is not so limited. For instance, vehicle 200 can represent a truck, a car, a semi-trailer truck, a motorcycle, a golf cart, an off-road vehicle, a farm vehicle, or any other vehicle that is described elsewhere herein (e.g., buses, boats, airplanes, helicopters, drones, lawn mowers, earth movers, submarines, all-terrain vehicles, snowmobiles, aircraft, recreational vehicles, amusement park vehicles, farm equipment, construction equipment or vehicles, warehouse equipment or vehicles, factory equipment or vehicles, trams, trains, trolleys, sidewalk delivery vehicles, and robot devices).

Vehicle 200 may include one or more sensor systems 202, 204, 206, 208, 210, 212, 214, and 218. In some embodiments, sensor systems 202, 204, 206, 208, 210, 212, 214, and/or 218 could represent one or more optical systems (e.g. cameras), one or more lidars, one or more radars, one or more inertial sensors, one or more humidity sensors, one or more acoustic sensors (e.g., microphones and sonar devices), or one or more other sensors configured to sense information about an environment that is surrounding vehicle 200. In other words, any sensor system now known or later created could be coupled to vehicle 200 and/or could be utilized in conjunction with various operations of vehicle 200. As an example, a lidar could be utilized in self-driving or other types of navigation, planning, perception, and/or mapping operations of vehicle 200. In addition, sensor systems 202, 204, 206, 208, 210, 212, 214, and/or 218 could represent a combination of sensors described herein (e.g., one or more lidars and radars; one or more lidars and cameras; one or more cameras and radars; or one or more lidars, cameras, and radars).

Note that the number, location, and type of sensor systems (e.g., 202 and 204) depicted in FIGS. 2A-E are intended as a non-limiting example of the location, number, and type of such sensor systems of an autonomous or semi-autonomous vehicle. Alternative numbers, locations, types, and configurations of such sensors are possible (e.g., to comport with vehicle size, shape, aerodynamics, fuel economy, aesthetics, or other conditions, to reduce cost, or to adapt to specialized environmental or application circumstances). For example, the sensor systems (e.g., 202 and 204) could be disposed of in various other locations on the vehicle (e.g., at location 216) and could have fields of view that correspond to internal and/or surrounding environments of vehicle 200.

The sensor system 202 may be mounted atop vehicle 200 and may include one or more sensors configured to detect information about an environment that is surrounding vehicle 200, and output indications of the information. For example, sensor system 202 can include any combination of cameras, radars, lidars, inertial sensors, humidity sensors, and acoustic sensors (e.g., microphones and sonar devices). The sensor system 202 can include one or more movable mounts that could be operable to adjust the orientation of one or more sensors in the sensor system 202. In one embodiment, the movable mount could include a rotating platform that could scan sensors so as to obtain information from each direction around vehicle 200. In another embodiment, the movable mount of the sensor system 202 could be movable in a scanning fashion within a particular range of angles and/or azimuths and/or elevations. The sensor system 202 could be mounted atop the roof of a car, although other mounting locations are possible.

Additionally, the sensors of sensor system 202 could be distributed in different locations and need not be collocated in a single location. Furthermore, each sensor of sensor system 202 can be configured to be moved or scanned independently of other sensors of sensor system 202. Additionally or alternatively, multiple sensors may be mounted at one or more of sensor systems 202, 204, 206, 208, 210, 212, 214, and/or 218. For example, there may be two lidar devices mounted at a sensor location and/or there may be one lidar device and one radar mounted at a sensor location.

The one or more sensor systems 202, 204, 206, 208, 210, 212, 214, and/or 218 could include one or more lidar devices. For example, the lidar devices could include a plurality of light-emitter devices arranged over a range of angles with respect to a given plane (e.g., the x-y plane). For example, one or more of sensor systems 202, 204, 206, 208, 210, 212, 214, and/or 218 may be configured to rotate or pivot about an axis (e.g., the z-axis) perpendicular to the given plane so as to illuminate an environment that is surrounding vehicle 200 with light pulses. Based on detecting various aspects of reflected light pulses (e.g., the elapsed time of flight, polarization, and intensity), information about the surrounding environment may be determined.

In an example embodiment, sensor systems 202, 204, 206, 208, 210, 212, 214, and/or 218 may be configured to provide respective point cloud information that may relate to physical objects within the surrounding environment of vehicle 200. While vehicle 200 and sensor systems 202, 204, 206, 208, 210, 212, 214, and 218 are illustrated as including certain features, it will be understood that other types of sensor systems are contemplated within the scope of the present disclosure. Further, vehicle 200 can include any of the components described in connection with vehicle 100 of FIG. 1.

In an example configuration, one or more radars can be located on vehicle 200. Similar to radar 126 described above, the one or more radars may include antennas configured to transmit and receive radio waves (e.g., electromagnetic waves having frequencies between 30 Hz and 300 GHz). Such radio waves may be used to determine the distance to and/or velocity of one or more objects in the surrounding environment of vehicle 200. For example, one or more sensor systems 202, 204, 206, 208, 210, 212, 214, and/or 218 could include one or more radars. In some examples, one or more radars can be located near the rear of vehicle 200 (e.g., sensor systems 208 and 210), to actively scan the environment near the back of vehicle 200 for the presence of radio-reflective objects. Similarly, one or more radars can be located near the front of vehicle 200 (e.g., sensor systems 212 or 214) to actively scan the environment near the front of vehicle 200. A radar can be situated, for example, in a location suitable to illuminate a region including a forward-moving path of vehicle 200 without occlusion by other features of vehicle 200. For example, a radar can be embedded in and/or mounted in or near the front bumper, front headlights, cowl, and/or hood, etc. Furthermore, one or more additional radars can be located to actively scan the side and/or rear of vehicle 200 for the presence of radio-reflective objects, such as by including such devices in or near the rear bumper, side panels, rocker panels, and/or undercarriage, etc.

Vehicle 200 can include one or more cameras. For example, the one or more sensor systems 202, 204, 206, 208, 210, 212, 214, and/or 218 could include one or more cameras. The camera can be a photosensitive instrument, such as a still camera, a video camera, a thermal imaging camera, a stereo camera, a night vision camera, etc., that is configured to capture a plurality of images of the surrounding environment of vehicle 200. To this end, the camera can be configured to detect visible light, and can additionally or alternatively be configured to detect light from other portions of the spectrum, such as infrared or ultraviolet light. The camera can be a two-dimensional detector, and can optionally have a three-dimensional spatial range of sensitivity. In some embodiments, the camera can include, for example, a range detector configured to generate a two-dimensional image indicating distance from the camera to a number of points in the surrounding environment. To this end, the camera may use one or more range detecting techniques. For example, the camera can provide range information by using a structured light technique in which vehicle 200 illuminates an object in the surrounding environment with a predetermined light pattern, such as a grid or checkerboard pattern and uses the camera to detect a reflection of the predetermined light pattern from environmental surroundings. Based on distortions in the reflected light pattern, vehicle 200 can determine the distance to the points on the object. The predetermined light pattern may comprise infrared light, or radiation at other suitable wavelengths for such measurements. In some examples, the camera can be mounted inside the front windshield of vehicle 200. Specifically, the camera can be situated to capture images from a forward-looking view with respect to the orientation of vehicle 200. Other mounting locations and viewing angles of the camera can also be used, either inside or outside vehicle 200. Further, the camera can have associated optics operable to provide an adjustable field of view. Still further, the camera can be mounted to vehicle 200 with a movable mount to vary a pointing angle of the camera, such as via a pan/tilt mechanism.

Vehicle 200 may also include one or more acoustic sensors (e.g., one or more of sensor systems 202, 204, 206, 208, 210, 212, 214, 216, 218 may include one or more acoustic sensors) used to sense a surrounding environment of vehicle 200. Acoustic sensors may include microphones (e.g., piezoelectric microphones, condenser microphones, ribbon microphones, or microelectromechanical systems (MEMS) microphones) used to sense acoustic waves (i.e., pressure differentials) in a fluid (e.g., air) of the environment that is surrounding vehicle 200. Such acoustic sensors may be used to identify sounds in the surrounding environment (e.g., sirens, human speech, animal sounds, or alarms) upon which control strategy for vehicle 200 may be based. For example, if the acoustic sensor detects a siren (e.g., an ambulatory siren or a fire engine siren), vehicle 200 may slow down and/or navigate to the edge of a roadway.

Although not shown in FIGS. 2A-2E, vehicle 200 can include a wireless communication system (e.g., similar to the wireless communication system 146 of FIG. 1 and/or in addition to the wireless communication system 146 of FIG. 1). The wireless communication system may include wireless transmitters and receivers that could be configured to communicate with devices external or internal to vehicle 200. Specifically, the wireless communication system could include transceivers configured to communicate with other vehicles and/or computing devices, for instance, in a vehicular communication system or a roadway station. Examples of such vehicular communication systems include DSRC, radio frequency identification (RFID), and other proposed communication standards directed towards intelligent transport systems.

Vehicle 200 may include one or more other components in addition to or instead of those shown. The additional components may include electrical or mechanical functionality.

A control system of vehicle 200 may be configured to control vehicle 200 in accordance with a control strategy from among multiple possible control strategies. The control system may be configured to receive information from sensors coupled to vehicle 200 (on or off vehicle 200), modify the control strategy (and an associated driving behavior) based on the information, and control vehicle 200 in accordance with the modified control strategy. The control system further may be configured to monitor the information received from the sensors, and continuously evaluate driving conditions; and also may be configured to modify the control strategy and driving behavior based on changes in the driving conditions. For example, a route taken by a vehicle from one destination to another may be modified based on driving conditions. Additionally or alternatively, the velocity, acceleration, turn angle, follow distance (i.e., distance to a vehicle ahead of the present vehicle), lane selection, etc. could all be modified in response to changes in the driving conditions.

As described above, in some embodiments, vehicle 200 may take the form of a van, but alternate forms are also possible and are contemplated herein. As such, FIGS. 2F-2I illustrate embodiments where vehicle 250 takes the form of a semi-truck. For example, FIG. 2F illustrates a front-view of vehicle 250 and FIG. 2G illustrates an isometric view of vehicle 250. In embodiments where vehicle 250 is a semi-truck, vehicle 250 may include tractor portion 260 and trailer portion 270 (illustrated in FIG. 2G). FIGS. 2H and 2I provide a side view and a top view, respectively, of the tractor portion 260. Similar to vehicle 200 illustrated above, vehicle 250 illustrated in FIGS. 2F-2I may also include a variety of sensor systems (e.g., similar to the sensor systems 202, 206, 208, 210, 212, 214 shown and described with reference to FIGS. 2A-2E). In some embodiments, whereas vehicle 200 of FIGS. 2A-2E may only include a single copy of some sensor systems (e.g., sensor system 204), vehicle 250 illustrated in FIGS. 2F-2I may include multiple copies of that sensor system (e.g., sensor systems 204A and 204B, as illustrated).

While drawings and description throughout may reference a given form of vehicle (e.g., semi-truck vehicle 250 or vehicle 200 shown as a van), it is understood that embodiments described herein can be equally applied in a variety of vehicle contexts (e.g., with modifications employed to account for a form factor of vehicle). For example, sensors and/or other components described or illustrated as being part of vehicle 200 could also be used (e.g., for navigation and/or obstacle detection and avoidance) in semi-truck vehicle 250

FIG. 2J illustrates various sensor fields of view (e.g., associated with vehicle 250 described above). As described above, vehicle 250 may contain a plurality of sensors/sensor units. The locations of the various sensors may correspond to the locations of the sensors disclosed in FIGS. 2F-2I, for example. However, in some instances, the sensors may have other locations. Sensors location reference numbers are omitted from FIG. 2J for simplicity of the drawing. For each sensor unit of vehicle 250, FIG. 2J illustrates a representative field of view (e.g., fields of view labeled as 252A, 252B, 252C, 252D, 254A, 254B, 256, 258A, 258B, and 258C). The field of view of a sensor may include an angular region (e.g., an azimuthal angular region and/or an elevational angular region) over which the sensor may detect objects.

FIG. 2K illustrates beam steering for a sensor of a vehicle (e.g., vehicle 250 shown and described with reference to FIGS. 2F-2J), according to example embodiments. In various embodiments, a sensor unit of vehicle 250 may be a radar, a lidar, a sonar, etc. Further, in some embodiments, during the operation of the sensor, the sensor may be scanned within the field of view of the sensor. Various different scanning angles for an example sensor are shown as regions 272, which each indicate the angular region over which the sensor is operating. The sensor may periodically or iteratively change the region over which it is operating. In some embodiments, multiple sensors may be used by vehicle 250 to measure regions 272. In addition, other regions may be included in other examples. For instance, one or more sensors may measure aspects of the trailer 270 of vehicle 250 and/or a region directly in front of vehicle 250.

At some angles, region of operation 275 of the sensor may include rear wheels 276A, 276B of trailer 270. Thus, the sensor may measure rear wheel 276A and/or rear wheel 276B during operation. For example, rear wheels 276A, 276B may reflect lidar signals or radar signals transmitted by the sensor. The sensor may receive the reflected signals from rear wheels 276A, 276. Therefore, the data collected by the sensor may include data from the reflections off the wheel.

In some instances, such as when the sensor is a radar, the reflections from rear wheels 276A, 276B may appear as noise in the received radar signals. Consequently, the radar may operate with an enhanced signal to noise ratio in instances where rear wheels 276A, 276B direct radar signals away from the sensor.

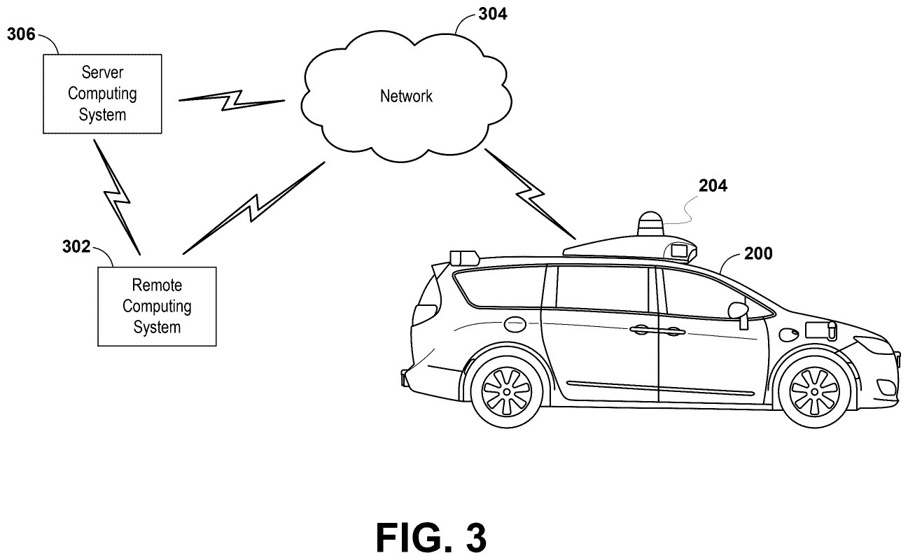

FIG. 3 is a conceptual illustration of wireless communication between various computing systems related to an autonomous or semi-autonomous vehicle, according to example embodiments. In particular, wireless communication may occur between remote computing system 302 and vehicle 200 via network 304. Wireless communication may also occur between server computing system 306 and remote computing system 302, and between server computing system 306 and vehicle 200.

Vehicle 200 can correspond to various types of vehicles capable of transporting passengers or objects between locations, and may take the form of any one or more of the vehicles discussed above. In some instances, vehicle 200 may operate in an autonomous or semi-autonomous mode that enables a control system to safely navigate vehicle 200 between destinations using sensor measurements. When operating in an autonomous or semi-autonomous mode, vehicle 200 may navigate with or without passengers. As a result, vehicle 200 may pick up and drop off passengers between desired destinations.

Remote computing system 302 may represent any type of device related to remote assistance techniques, including but not limited to those described herein. Within examples, remote computing system 302 may represent any type of device configured to (i) receive information related to vehicle 200, (ii) provide an interface through which a human operator can in turn perceive the information and input a response related to the information, and (iii) transmit the response to vehicle 200 or to other devices. Remote computing system 302 may take various forms, such as a workstation, a desktop computer, a laptop, a tablet, a mobile phone (e.g., a smart phone), and/or a server. In some examples, remote computing system 302 may include multiple computing devices operating together in a network configuration.

Remote computing system 302 may include one or more subsystems and components similar or identical to the subsystems and components of vehicle 200. At a minimum, remote computing system 302 may include a processor configured for performing various operations described herein. In some embodiments, remote computing system 302 may also include a user interface that includes input/output devices, such as a touchscreen and a speaker. Other examples are possible as well.

Network 304 represents infrastructure that enables wireless communication between remote computing system 302 and vehicle 200. Network 304 also enables wireless communication between server computing system 306 and remote computing system 302, and between server computing system 306 and vehicle 200.

The position of remote computing system 302 can vary within examples. For instance, remote computing system 302 may have a remote position from vehicle 200 that has wireless communication via network 304. In another example, remote computing system 302 may correspond to a computing device within vehicle 200 that is separate from vehicle 200, but with which a human operator can interact while a passenger or driver of vehicle 200. In some examples, remote computing system 302 may be a computing device with a touchscreen operable by the passenger of vehicle 200.

In some embodiments, operations described herein that are performed by remote computing system 302 may be additionally or alternatively performed by vehicle 200 (i.e., by any system(s) or subsystem(s) of vehicle 200). In other words, vehicle 200 may be configured to provide a remote assistance mechanism with which a driver or passenger of the vehicle can interact.

Server computing system 306 may be configured to wirelessly communicate with remote computing system 302 and vehicle 200 via network 304 (or perhaps directly with remote computing system 302 and/or vehicle 200). Server computing system 306 may represent any computing device configured to receive, store, determine, and/or send information relating to vehicle 200 and the remote assistance thereof. As such, server computing system 306 may be configured to perform any operation(s), or portions of such operation(s), that is/are described herein as performed by remote computing system 302 and/or vehicle 200. Some embodiments of wireless communication related to remote assistance may utilize server computing system 306, while others may not.

Server computing system 306 may include one or more subsystems and components similar or identical to the subsystems and components of remote computing system 302 and/or vehicle 200, such as a processor configured for performing various operations described herein, and a wireless communication interface for receiving information from, and providing information to, remote computing system 302 and vehicle 200.

The various systems described above may perform various operations. These operations and related features will now be described.

In line with the discussion above, a computing system (e.g., remote computing system 302, server computing system 306, or a computing system local to vehicle 200) may operate to use a camera to capture images of the surrounding environment of an autonomous or semi-autonomous vehicle. In general, at least one computing system will be able to analyze the images and possibly control the autonomous or semi-autonomous vehicle.

In some embodiments, to facilitate autonomous or semi-autonomous operation, a vehicle (e.g., vehicle 200) may receive data representing objects in an environment surrounding the vehicle (also referred to herein as “environment data”) in a variety of ways. A sensor system on the vehicle may provide the environment data representing objects of the surrounding environment. For example, the vehicle may have various sensors, including a camera, a radar, a lidar, a microphone, a radio unit, and other sensors. Each of these sensors may communicate environment data to a processor in the vehicle about information each respective sensor receives.

In one example, a camera may be configured to capture still images and/or video. In some embodiments, the vehicle may have more than one camera positioned in different orientations. Also, in some embodiments, the camera may be able to move to capture images and/or video in different directions. The camera may be configured to store captured images and video to a memory for later processing by a processing system of the vehicle. The captured images and/or video may be the environment data. Further, the camera may include an image sensor as described herein.

In another example, a radar may be configured to transmit an electromagnetic signal that will be reflected by various objects near the vehicle, and then capture electromagnetic signals that reflect off the objects. The captured reflected electromagnetic signals may enable the radar (or processing system) to make various determinations about objects that reflected the electromagnetic signal. For example, the distances to and positions of various reflecting objects may be determined. In some embodiments, the vehicle may have more than one radar in different orientations. The radar may be configured to store captured information to a memory for later processing by a processing system of the vehicle. The information captured by the radar may be environmental data.

In another example, a lidar may be configured to transmit an electromagnetic signal (e.g., infrared light, such as that from a gas or diode laser, or other possible light source) that will be reflected by target objects near the vehicle. The lidar may be able to capture the reflected electromagnetic (e.g., infrared light) signals. The captured reflected electromagnetic signals may enable the range-finding system (or processing system) to determine a range to various objects. The lidar may also be able to determine a velocity or speed of target objects and store it as environment data.

Additionally, in an example, a microphone may be configured to capture audio of the environment surrounding the vehicle. Sounds captured by the microphone may include emergency vehicle sirens and the sounds of other vehicles. For example, the microphone may capture the sound of the siren of an ambulance, fire engine, or police vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some embodiments it is desirable to transmit the first electromagnetic radiation signal with a signaling mode that requests a response from devices located near the autonomous or semi-autonomous vehicle. The processing system may be able to detect nearby devices based on the responses communicated back to the radio unit and use this communicated information as a portion of the environment data.

In some embodiments, the processing system may be able to combine information from the various sensors in order to make further determinations of the surrounding environment of the vehicle. For example, the processing system may combine data from both radar information and a captured image to determine if another vehicle or pedestrian is in front of the autonomous or semi-autonomous vehicle. In other embodiments, other combinations of sensor data may be used by the processing system to make determinations about the surrounding environment.

While operating in an autonomous mode (or semi-autonomous mode), the vehicle may control its operation with little-to-no human input. For example, a human-operator may enter an address into the vehicle and the vehicle may then be able to drive, without further input from the human (e.g., the human does not have to steer or touch the brake/gas pedals), to the specified destination. Further, while the vehicle is operating autonomously or semi-autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc. When a processing system in the vehicle identifies objects near the vehicle, the vehicle may be able to change velocity, or alter the movement in another way.

When the vehicle detects an object but is not highly confident in the detection of the object, the vehicle can request a human operator (or a more powerful computer) to perform one or more remote assistance tasks, such as (i) confirm whether the object is in fact present in the surrounding environment (e.g., if there is actually a stop sign or if there is actually no stop sign present), (ii) confirm whether the vehicle's identification of the object is correct, (iii) correct the identification if the identification was incorrect, and/or (iv) provide a supplemental instruction (or modify a present instruction) for the autonomous or semi-autonomous vehicle. Remote assistance tasks may also include the human operator providing an instruction to control operation of the vehicle (e.g., instruct the vehicle to stop at a stop sign if the human operator determines that the object is a stop sign), although in some scenarios, the vehicle itself may control its own operation based on the human operator's feedback related to the identification of the object.

To facilitate this, the vehicle may analyze the environment data representing objects of the surrounding environment to determine at least one object having a detection confidence below a threshold. A processor in the vehicle may be configured to detect various objects of the surrounding environment based on environment data from various sensors. For example, in one embodiment, the processor may be configured to detect objects that may be important for the vehicle to recognize. Such objects may include pedestrians, bicyclists, street signs, other vehicles, indicator signals on other vehicles, and other various objects detected in the captured environment data.

The detection confidence may be indicative of a likelihood that the determined object is correctly identified in the surrounding environment, or is present in the surrounding environment. For example, the processor may perform object detection of objects within image data in the received environment data, and determine that at least one object has the detection confidence below the threshold based on being unable to identify the object with a detection confidence above the threshold. If a result of an object detection or object recognition of the object is inconclusive, then the detection confidence may be low or below the set threshold.

The vehicle may detect objects of the surrounding environment in various ways depending on the source of the environment data. In some embodiments, the environment data may come from a camera and be image or video data. In other embodiments, the environment data may come from a lidar. The vehicle may analyze the captured image or video data to identify objects in the image or video data. The methods and apparatuses may be configured to monitor image and/or video data for the presence of objects of the surrounding environment. In other embodiments, the environment data may be radar, audio, or other data. The vehicle may be configured to identify objects of the surrounding environment based on the radar, audio, or other data.

In some embodiments, the techniques the vehicle uses to detect objects may be based on a set of known data. For example, data related to environmental objects may be stored to a memory located in the vehicle. The vehicle may compare received data to the stored data to determine objects. In other embodiments, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other embodiments, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some embodiments, the vehicle may react as if the detected object is present despite the low confidence level. In other embodiments, the vehicle may react as if the detected object is not present.

When the vehicle detects an object of the surrounding environment, it may also calculate a confidence associated with the specific detected object. The confidence may be calculated in various ways depending on the embodiment. In one example, when detecting objects of the surrounding environment, the vehicle may compare environment data to predetermined data relating to known objects. The closer the match between the environment data and the predetermined data, the higher the confidence. In other embodiments, the vehicle may use mathematical analysis of the environment data to determine the confidence associated with the objects.

In response to determining that an object has a detection confidence that is below the threshold, the vehicle may transmit, to the remote computing system, a request for remote assistance with the identification of the object. As discussed above, the remote computing system may take various forms. For example, the remote computing system may be a computing device within the vehicle that is separate from the vehicle, but with which a human operator can interact while a passenger or driver of the vehicle, such as a touchscreen interface for displaying remote assistance information. Additionally or alternatively, as another example, the remote computing system may be a remote computer terminal or other device that is located at a location that is not near the vehicle.

The request for remote assistance may include the environment data that includes the object, such as image data, audio data, etc. The vehicle may transmit the environment data to the remote computing system over a network (e.g., network 304), and in some embodiments, via a server (e.g., server computing system 306). The human operator of the remote computing system may in turn use the environment data as a basis for responding to the request.

In some embodiments, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing the velocity of the vehicle (e.g., a speed and/or direction), among other possible adjustments.

In other embodiments, even if the vehicle detects an object having a confidence that meets or exceeds the threshold, the vehicle may operate in accordance with the detected object (e.g., come to a stop if the object is identified with high confidence as a stop sign), but may be configured to request remote assistance at the same time as (or at a later time from) when the vehicle operates in accordance with the detected object.

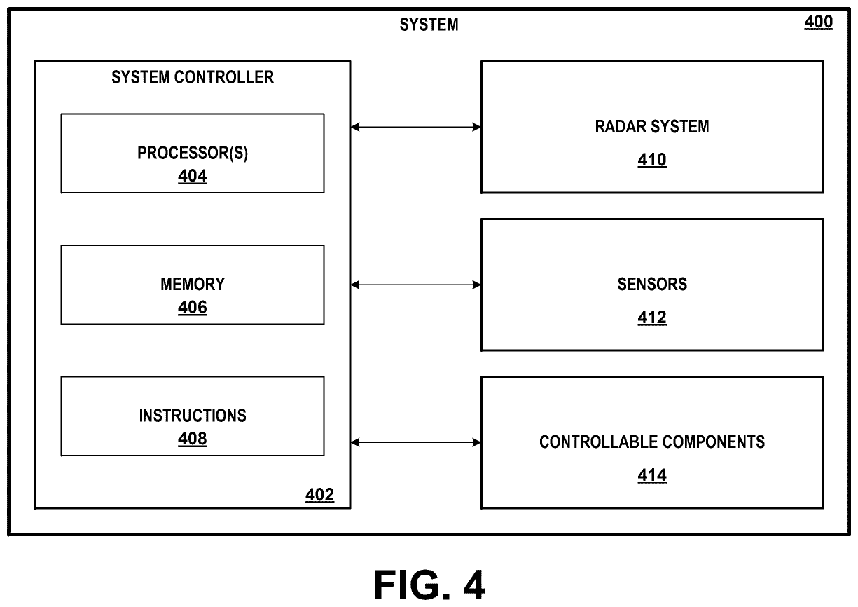

FIG. 4 is a block diagram of a system, according to example embodiments. In particular, FIG. 4 shows system 400 that includes system controller 402, radar system 410, sensors 412, and controllable components 414. System controller 402 includes processor(s) 404, memory 406, and instructions 408 stored on memory 406 and executable by processor(s) 404 to perform functions, such as the operations disclosed herein.

Processor(s) 404 can include one or more processors, such as one or more general-purpose microprocessors (e.g., having a single core or multiple cores) and/or one or more special purpose microprocessors. The one or more processors may include, for instance, one or more central processing units (CPUs), one or more microcontrollers, one or more graphical processing units (GPUs), one or more tensor processing units (TPUs), one or more ASICs, and/or one or more field-programmable gate arrays (FPGAs). Other types of processors, computers, or devices configured to carry out software instructions are also contemplated herein.

Memory 406 may include a computer-readable medium, such as a non-transitory, computer-readable medium, which may include without limitation, read-only memory (ROM), programmable read-only memory (PROM), erasable programmable read-only memory (EPROM), electrically erasable programmable read-only memory (EEPROM), non-volatile random-access memory (e.g., flash memory), a solid state drive (SSD), a hard disk drive (HDD), a Compact Disc (CD), a Digital Video Disk (DVD), a digital tape, read/write (R/W) CDs, R/W DVDs, etc.

Radar system 410 can be used in autonomous or semi-autonomous vehicles for navigation and object detection by using radio waves to detect and measure the distance, speed, and direction of objects in the surrounding environment. Radar system 410 can include one or multiple radar units, which each consists of a radar transmitter that emits radio waves and a radar receiver that captures the reflected waves from objects. By analyzing the time it takes for the waves to return and their frequency shifts (Doppler Effect), radar system 410 can determine the presence, location, and movement of objects.

In the context of autonomous or semi-autonomous vehicles, radar system 410 provides measurements that can assist with navigation and collision avoidance. Radar units are typically mounted on the vehicle's exterior, such as the front, rear, and sides. During navigation, radar system 410 may continuously emit radio waves in various directions, scanning the environment around the vehicle. When the waves encounter an object, they bounce back to a radar receiver, thereby enabling radar system 410 to analyze the reflected waves to calculate the distance, relative speed, and angle of the object. This information can be used by the vehicle's control system to make decisions and adjust the vehicle's trajectory accordingly, enabling it to detect and react to obstacles, pedestrians, vehicles, and other potential hazards in its path. By providing real-time data about the surrounding environment, radar system 410 can enhance the vehicle's perception capabilities and contribute to safer and more reliable navigation.

Radar system 410 offers operational benefits over other types of sensors in some aspects, such as cameras and lidar. Radar can perform well in adverse weather conditions, such as rain, fog, or dust, where other sensors might be limited. In particular, radio waves emitted by radar system 410 can penetrate these adverse conditions and provide reliable object detection. This makes radar particularly useful for enhancing the robustness and safety of autonomous or semi-autonomous vehicles in various weather scenarios. In addition, radar also excels at detecting the velocity and relative speed of nearby objects, which is useful for assessing the movement of surrounding vehicles, pedestrians, and other obstacles. By providing accurate speed information, radar system 410 enables the vehicle (or a driver of the vehicle) to make informed decisions about potential collision risks and adjust its behavior accordingly. In some cases, radar system 410 can also offer a longer range of measurements and broader field of view when compared to other sensors coupled to the vehicle.

Similarly, system controller 402 may use outputs from radar system 410 and sensors 412 to determine the characteristics of system 400 and/or characteristics of the surrounding environment. For example, sensors 412 may include one or more of a GPS, an IMU, an image capture device (e.g., a camera), a light sensor, a heat sensor, one or more lidar devices, and other sensors indicative of parameters relevant to system 400 and/or the surrounding environment. Radar system 410 is depicted as separate from sensors 412 for purposes of example, and may be considered as part of or as sensors 412 in some examples.

Based on characteristics of system 400 and/or the surrounding environment determined by system controller 402 based on the outputs from radar system 410 and the sensors 412, system controller 402 may control the controllable components 414 to perform one or more actions. For example, system 400 may correspond to a vehicle, in which case the controllable components 414 may include a braking system, a turning system, and/or an accelerating system of the vehicle, and system controller 402 may change aspects of these controllable components based on characteristics determined from radar system 410 and/or sensors 412 (e.g., when system controller 402 controls the vehicle in an autonomous or semi-autonomous mode). Within examples, radar system 410 and sensors 412 are also controllable by system controller 402.

In some examples, radars within radar system 410 and other sensors may use radomes or other structures that position frequency selective structures described herein near radiating surfaces (e.g., the transmitter and receiver components). The use of frequency selective structures can help ensure optimal performance by radar system 410 and other sensors. In some cases, the frequency selective structures may increase in temperature to keep sensors operating within a particular temperature range for optimal operations or to melt off snow or ice. Frequency selective structures can also serve as band-pass filters for limiting the frequencies used by radars or other sensors. The position and orientation of frequency selective structures

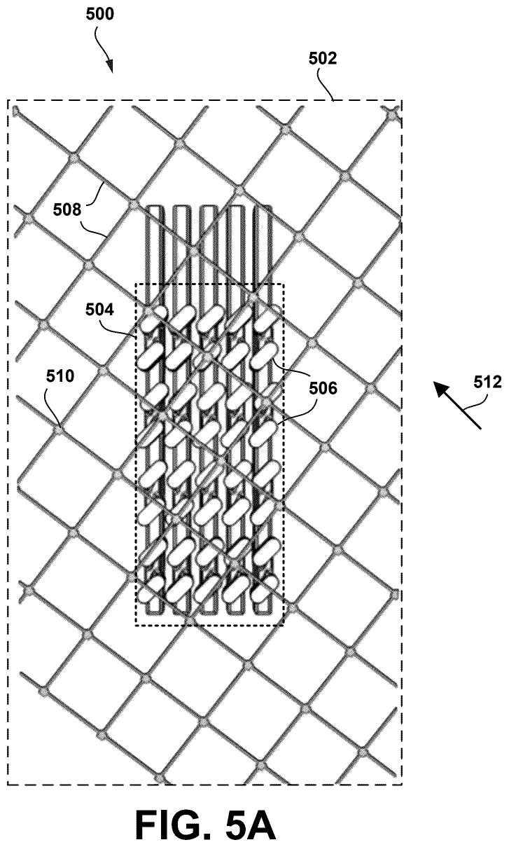

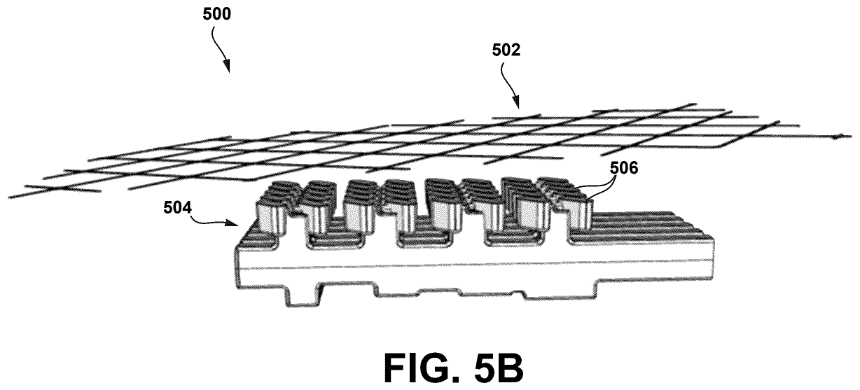

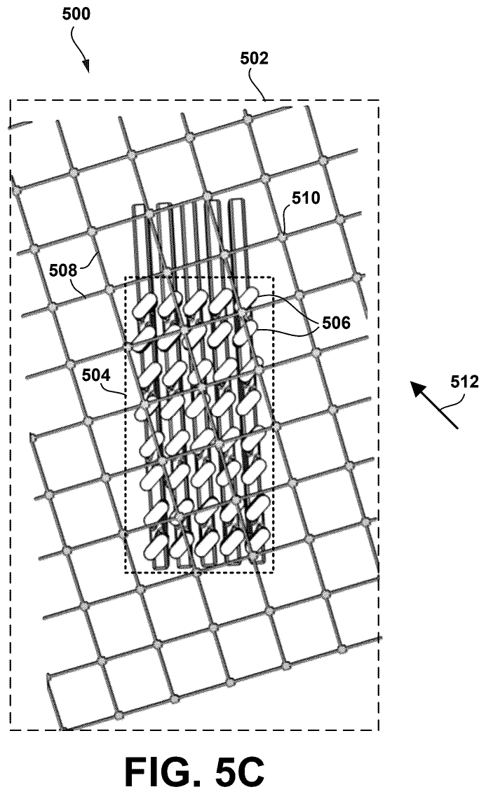

FIGS. 5A, 5B, and 5C depict various views of system 500, which incorporates frequency selective structure 502 at a position in front of radiating surface 504 and antennas 506 located as part of radiating surface 504. By using such an arrangement, frequency selective structure 502 can be used to optimize performance of antennas 506 in various conditions. For instance, system 500 may be implemented as part of a radar unit with frequency selective structure 502 mounted on a radome to augment the performance of antennas 506 on radiating surface 504 as the radar performs in various conditions. Multiple systems may be implemented on a vehicle as part of a vehicle radar system. In other examples, system 500 may represent components that are used for other types of sensors.

As shown in FIGS. 5A, 5B, and 5C, frequency selective structure 502 includes micro-wires 508, which are arranged in intersecting arrays that form a grid-like pattern. In particular, the arrays of micro-wires 508 includes a first set of metal traces aligned in parallel at a positive slant angle (e.g., positive 45 degrees) and a second set of metal traces aligned in parallel at a negative slant angle (e.g., negative 45 degrees). The slope of these angles can differ and the quantity of arrays of micro-wires can differ within examples. For instance, another frequency selective structure may include a combination of arrays of micro-wires arranged in horizontal, vertical, and/or sloped orientations.

The intersections formed by crossing micro-wires 508 may influence performance of antennas 506 and also create potential sites for the placement of patches 510 or other frequency selective elements. In some cases, the spacing of micro-wires 508 is set approximately based on the wavelength of the desired operating frequency for antennas 506, which helps facilitate effective operation by system 500 across a spectrum of frequencies. The specific arrangement and spacing of micro-wires 508 may depend on the desired performance criteria of system 500, such as tuning the frequency response or optimizing for a particular frequency range. In particular, frequency selective structure 502 may be configured to optimize a desired band-pass for specific performance by the one or more antennas 506. This may involve tuning frequency selective structure 502 to allow signals within a particular frequency range to pass through, while blocking or attenuating signals outside of this range. The desired band-pass implemented by frequency selective structure 502 may be selected based on the specific requirements of system 500, such as the operating frequency and/or the desired range of detection.

The tuning of frequency selective structure 502 to specific frequencies can depend on adjusting its physical and geometrical attributes. The conductive elements that make up the frequency selective structure 502, such as patches 510 and slots, can be engineered with particular dimensions and shapes to resonate at desired frequencies. By varying these dimensions, the resonant frequency can be adjusted to target specific points in the frequency spectrum. Larger elements may be used to resonant at lower frequencies, while smaller elements may be used for higher frequencies. The periodicity, or the repetitive spacing between these elements, can also impact the bandwidth characteristics of frequency selective structure 502, with closer spacing resulting in a narrower bandwidth and wider spacing allowing for a broader frequency range.

The material properties of frequency selective structure 502 can also influence performance during the tuning process. The dielectric constant of the substrate material directly impacts the resonant frequency of frequency selective structure 502. In particular, a higher dielectric constant may result in a lower resonant frequency, whereas a lower dielectric constant can increase the resonant frequency. Additionally, the thickness of the dielectric substrate is another parameter that can be adjusted to fine-tune frequency selective structure 502. A thicker substrate may generally lead to a lower resonant frequency, while a thinner substrate can raise the resonant frequency. This interplay between material properties and geometric design is central to achieving the precise frequency selectivity desired.

In some examples, a frequency selective structure may consist of multiple layers of conductive elements, each separated by dielectric materials. This multilayered approach may allow for the creation of sophisticated filtering profiles, which can be capable of targeting multiple frequencies or achieving sharp transitions at the band edges. To ensure the design meets the specific requirements, computational electromagnetic (CEM) simulations may be used. The simulations may be used to model the behavior of the frequency selective structure under various conditions and enable designers to optimize its parameters for the intended frequency response. Following the simulation phase, physical prototypes may be constructed and subjected to rigorous testing. If the prototype's performance deviates from the expected specifications, the design can be iteratively refined until the frequency selective structure operates within the desired frequency parameters. This cycle of design, simulation, prototyping, and testing can be used to finely tune a frequency selective structure to the specific frequencies for its intended application.

In addition, frequency selective structure 502 may be positioned and oriented with a rotational angle relative to the polarization of antennas 506 (represented by arrow 512) on radiating surface 504. The polarization for an antenna or array of antennas refers to the orientation of the electric field of the radio waves that the antenna or antennas emit and/or receive. The electric field can oscillate in various directions. In some cases, polarization may be linear (where the electric field oscillates in a single plane, such as horizontal, vertical, or a slanted polarization), circular (where the electric field rotates in a circle, either clockwise or counterclockwise), and elliptical (a general form where the electric field describes an ellipse). The polarization of an antenna can impact the antenna's ability to transmit or receive waves with respect to the orientation of other antennas or scattering objects. In particular, when the polarization of the transmitted radar wave matches the orientation of the target's reflective surfaces, the reflected signal is stronger, which results in better detection capabilities. Conversely, if the polarizations are mismatched, the reflected signal may be weaker, which may make the target more difficult to detect. Additionally, polarization can be used to filter out unwanted signals or clutter by selecting a polarization that is less likely to be reflected by non-target objects. This can enhance the ability of the radar system to distinguish between different types of targets and reduce the effects of interference, thereby improving overall radar performance and accuracy.

In FIG. 5A and FIG. 5C, arrow 512 is shown in a slanted direction indicating that the polarization of antenna 506 may transmit and/or receive radio waves with a slanted (e.g., 45 degrees) polarization. In other cases, the polarization of antennas 506 may be horizontal, vertical, or slanted at a different angle within examples. FIG. 5A and FIG. 5B show different views of system 500 with frequency selective structure 502 positioned and oriented at particular rotational angle relative to the polarization of antennas 506 (e.g., +7.5 degree rotation) while FIG. 5C shows frequency selective structure 502 repositioned at a different rotational angle relative to the polarization antennas 506 (31.5 degree rotation). Adjusting the rotational angle of frequency selective structure 502 relative to the polarization of antennas 506 (represented by arrow 512) can optimize antenna performance for desired use, including influencing elevation patterns and reducing sidelobe levels. For example, the rotational angle can be fine-tuned to minimize return reflections, which may result in increased signal clarity and reduced interference.

In some examples, a computing system may perform simulations to identify an optimal rotational angle for positioning a frequency selective structure relative to underlying antennas. The simulations may factor different parameters, such as desired sidelobe levels and elevation patterns for the desired use for the antennas. The simulations can also consider changes in other parameters of the frequency selective structure 502, such as modifying parameters related to patches 510 and micro-wires 508, to optimize the performance of antennas 506 based on desired performance metrics. Some parameters for patches 510 that can be altered and adjusted via iterative simulations include adjusting the size, offsets, material, quantity, arrangement, quantity, and/or shapes. Some parameters for micro-wires 508 that can be adjusted via iterative simulations include thickness, position, material, quantity, spacing, arrangement, and orientation relative to other micro-wires. By using optimization algorithms integrated within simulation software, designers can define a set of performance goals for the frequency selective structure, such as achieving a specific bandwidth or minimizing insertion loss at particular frequencies. The software can then automatically adjust design parameters to meet these objectives, which may involve using methods like genetic algorithms, gradient-based optimization, or particle swarm optimization. In some cases, simulations can also be used to evaluate the frequency selective structure under a range of incident angles and polarizations, which can be useful for replicating the performance of radars that operate in diverse conditions. Through the use of simulations, the design of frequency selective structures can be refined to achieve an optimized balance between performance, cost, and manufacturability.

The material composition of frequency selective structure 502 (and individual components in general) can vary within examples, which may include metals, alloys, dielectrics, and/or semiconductors selected based on desired electrical and mechanical properties, cost, and/or availability. Metals or alloys, which can have high electrical conductivity properties, are advantageous for the heating function of frequency selective structure 502. In some cases, dielectrics or semiconductors may be selected for forming frequency selective structure 502 (or a portion of frequency selective structure 502) for these materials' specific frequency response characteristics that are beneficial for filtering. The material or materials selected and used to form frequency selective structure 502 may also be designed to have high thermal conductivity and resistance to corrosion, ensuring efficient heat distribution for melting accumulated snow or rain and withstanding exposure to such elements.

Frequency selective structure 502 may also have super hydrophobic features/properties to repel water, which prevents rain accumulation and helps to maintain radar performance during heavy rain. In some cases, the super hydrophobic properties of frequency selective structure 502 may be achieved through the application of one or more special coatings or by engineering a specific surface texture on frequency selective structure 502. Additionally, frequency selective structure 502 may also leverage heating properties that, when activated by current, increases the temperature of frequency selective structure 502 to melt precipitation off the radome, ensuring the effective operation of system 500 in adverse weather conditions. The heating capability by frequency selective structure 502 may be used to also help maintain the temperature of frequency selective structure 502 (and other components within system 500) within an optimum range that is beneficial for radar performance.

Heating frequency selective structure 502 does not inherently cause additional filtering of electromagnetic waves from antennas 506. In particular, frequency selective structure 502 is designed to filter electromagnetic signals based on frequency, not their temperature. The filtering effect of frequency selective structure 502 is determined by its physical structure, including the shape, size, and arrangement of its conductive elements as well as the electrical properties of its materials. In some cases, when frequency selective structure 502 is heated, the physical dimensions of frequency selective structure 502 may change slightly due to thermal expansion and the electrical properties of the materials, such as conductivity, can also be affected. These changes, however, are typically small and likely do not result in a new filtering effect. Instead, the changes may cause a slight shift in the resonant frequency of frequency selective structure 502 or alter its efficiency slightly, but the overall filtering behavior based on frequency selectivity remains the same. In addition, materials and designs for frequency selective structure 502 can be selected to ensure stability over a range of operating temperatures to prevent any substantial degradation in performance. As such, frequency selective structure 502 can operate as desired in a range of temperatures that may be experienced by a vehicle navigating in different environments.

In addition to micro-wires 508, frequency selective structure 502 is shown with patches 510, which can be positioned at various locations on frequency selective structure 502, not limited to intersections of micro-wires. This flexibility in patch placement allows for a more customized structure configuration, enhancing performance for specific applications or operating conditions. Patches 510 can be arranged in staggered, clustered, random, or other beneficial arrangements, and their shapes can vary, including polygonal forms like squares, circles, hexagons, etc. In some cases, patches 510 may have more complex shapes like crosses or rings. The choice of patch shape may be based on factors, such as desired frequency response and heating capability, with the aim of optimizing the structure for particular operational frequencies and/or high heating efficiency.

In some examples, a frequency selective structure may include at least a first patch having a first polygonal shape and a second patch having a second polygonal shape that differs from the first polygonal shape. For instance, the first polygonal shape may be a circular shape and the second polygonal shape may be a non-circular shape. Patches can be circular and uniform in size in some examples. In other cases, patches can have different sizes.

Materials used for patches can be uniform or differ within examples. The choice of materials for patches 510 can be selected based on desired electromagnetic properties and the intended application for frequency selective structure 502. For instance, copper, aluminum, silver, and other metals may be used due to their high electrical conductivity, which can enhance reflecting and conducting electromagnetic waves. In some cases, patches 510 may use conductive paints and inks that contain particles of conductive materials, like silver or graphite. Dielectric materials may also be used to support conductive patches and can be tailored to have specific permittivity values, affecting the resonant frequency of frequency selective structure 502. For instance, FR4, Teflon-based composites, and Roger materials are some examples of dielectric substrates that may be used.

The thickness of patches 510 can vary and depend on desired design requirements. For instance, the thickness of the conductive patches can be less than a millimeter and may be in the range of micrometers. As such, patches 510 can be thicker than micro-wires 508 in some examples and thinner than micro-wires 508 in other examples. The depth of the material at the operating frequency can be factored during design of frequency selective structure 502.

In some cases, one or more patches 510 can be located offset from the center of a corresponding intersection. The distance of the offset can vary and may depend on results generated via simulations. In some examples, frequency selective structure 502 may be designed without any patches. In some instances, at least one path may be located on a micro-wire at a threshold distance from the intersections formed by the arrays of micro-wires. The arrangement of patches 510 in a periodic lattice may affect the band-pass or band-stop characteristics while the distance between adjacent patches may influence the coupling between elements the overall frequency response. In addition, the orientation of patches 510 can be designed to respond to specific polarizations of incident electromagnetic waves, which can be particularly useful in polarization-sensitive applications.

In some examples, multiple layers of patches and substrates can be used to create a multi-band or broadband frequency selective structure. The spacing and interaction between layers are additional parameters that can be adjusted during design simulations.

Vehicle systems may use system 500 equipped with frequency selective structure 502 to improve the performance of individual radars or other types of sensors, which can include optimizing band-pass for specific antenna functions, melting precipitation to maintain clear radome surfaces, and/or adjusting structural properties to meet the demands of various environmental conditions and operational requirements. In addition, vehicle systems may also use sensor data to determine when to adjust the temperature of one or more frequency selective structures associated with radar or other types of sensors on the vehicle. For instance, vehicle systems may detect a change in resonance of a circuit that includes a frequency selective structure or compare resonance levels of multiple frequency selective structures to detect when one or multiple radomes may be covered with debris, ice, or other elements that impact performance. In some cases, frequency selective structure 502 may be used with other types of sensors, such as lidar or cameras.

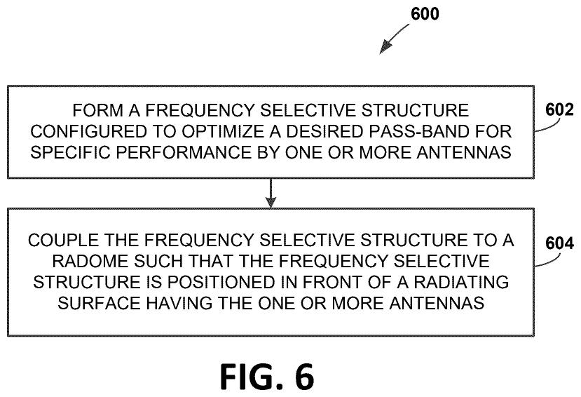

FIG. 6 is a flowchart of a method for forming a system that uses a frequency selective structure. Method 600 may include one or more operations, functions, or actions as illustrated by one or more of blocks 602 and 604. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for method 600 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or memory, for example, such as a storage device including a disk or hard drive. Various types of manufacturing processes, including automated processes, can be used to perform method 600. In addition, a variety of machines can be used to perform blocks of method 600.

At block 602, method 600 involves forming a frequency selective structure configured to optimize a desired band-pass for specific performance by one or more antennas. The frequency selective structure may comprise arrays of micro-wires forming a plurality of intersections and one or more patches positioned at one or more intersections of the plurality of intersections. In some cases, at least one patch of the one or more patches is positioned with an offset relative to a corresponding intersection of the one or more intersections. The frequency selective structure has a rotational angle with respect to an antenna polarization of the one or more antennas.

In some examples, the design of the frequency selective structure can differ. For instance, the micro-wires can have different configurations, angles, and/or orientations, which may change the configuration of intersections formed by the micro-wires. In addition, some frequency selective structures may include more or fewer patches. Some examples may be implemented without any patches.

Simulations may be used in the initial stages of frequency selective structure development to enable engineers to design, optimize, and refine a frequency selective structure in a virtual environment, which can save time and resources compared to physical prototyping. For example, a degree of the rotational angle can be based on signal transmission simulations. In some instances, computational electromagnetics tools are used to model the frequency selective structure, allowing for the analysis of various parameters, such as element size, shape, periodicity, position, shape, and quantity of patches, and material properties. The simulations can provide insights into the electromagnetic performance of the frequency selective structure, including its ability to filter specific frequency bands, and can also be used to conduct thermal analysis of the frequency selective structure.

To generate the frequency selective structure, manufacturing processes may use the results of these simulations, which may include using the results to select materials that meet the electrical and mechanical requirements of the frequency selective structure. Materials can range from metals and alloys to dielectrics and semiconductor material, depending on the application. Advanced fabrication techniques, such as photolithography, laser cutting, chemical etching, and 3D printing can be used to create the frequency selective structure, with the chosen method depending on the design's complexity, material considerations, and cost efficiency. Once a prototype is manufactured, the prototype may be tested to ensure that the physical characteristics of the frequency selective structure align with the simulation predictions. This stage is used to verify the frequency selective structure's performance and identify any areas that may require further design adjustments. Quality control is reviewed and focused upon throughout the manufacturing process to maintain strict tolerances and ensure that each unit meets the established performance criteria.

At block 604, method 600 involves coupling the frequency selective structure to a radome such that the frequency selective structure is positioned in front of a radiating surface having one or more antennas. The orientation and the position of the frequency selective structure relative to the radiating surface may differ within examples and may depend on the configuration between the radome and the radiating surface.

The final step in the frequency selective structure development process may involve integrating the manufactured frequency selective structure with other system components, such as antennas or radomes. Once integrated, further testing may be performed using the associated sensor (e.g., radar) in real-world applications.

Methods 600 may further involve performing simulations to determine a configuration for the frequency selective structure. The simulations can factor the performance of a system that uses different physical designs of the frequency selective structure to enable an optimal design to be identified. Different weights can be used when performing the simulations to test designs with different parameters for the micro-wires, patches, rotational angle, orientation and position of the frequency selective structure relative to a radiating surface, among other factors, to develop a design for creating the frequency selective structure.

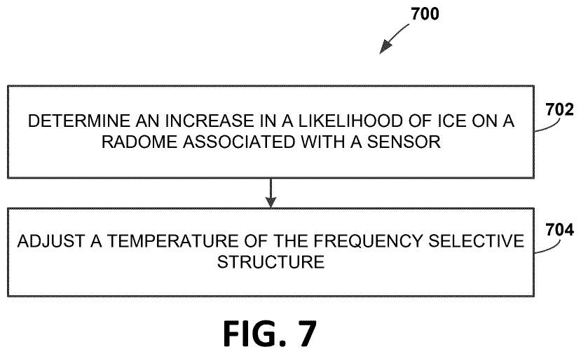

FIG. 7 is a flowchart of a method of a system using a frequency selective structure. Method 700 may include one or more operations, functions, or actions as illustrated by one or more of blocks 702 and 704. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

At block 702, method 700 involves determining an increase in a likelihood of ice on a radome associated with a sensor, wherein a frequency selective structure is coupled to the radome. The sensor may be a radar or another type of sensor that uses the radome for protection.

In some examples, the method may determine the increase in the likelihood of ice coupled to the radome based on detecting a change in a resonant frequency of a circuit comprising a frequency selective structure. For instance, a computing system may detect the presence of ice or other material on the radome by observing shifts in the resonant frequencies of the frequency selective structure. In particular, ice on the radome alters its dielectric properties, which can affect the designed resonant frequencies of the frequency selective structure coupled to the radome. Detecting the shifts in the resonant frequencies can signal that the electromagnetic characteristics of the radome have changed, possibly due to ice formation.

In some examples, a system that uses the frequency selective structure may infer the presence of ice on a radome based on changes in radar performance. Ice accumulation can lead to signal attenuation since the ice layer on the radome may absorb or scatter radar waves, decreasing the strength of received signals. A computing system may monitor for a decrease in signal strength to indirectly detect ice buildup on a radome.

In some examples, a computing system may analyze the standing wave ratio or reflection coefficients to detect when ice causes an impedance mismatch at the interface between the antennas and the radome. Similarly, the computing system may also determine an increase in likelihood of ice on the radome based on detecting a distortion in the radiation pattern of the antennas. Ice may affect the direction and strength of the main lobe and sidelobes of the radiation pattern. As such, such distortions may be due to the accumulation of ice on the radome.

In addition, a computing system may use sensor data from additional sensors to determine the increased likelihood of ice on the radome. For instance, temperature sensors can monitor the surface temperature of the radome or the temperature of the environment of a vehicle in general. The temperature data can indicate if current conditions may lead to ice formation. In some cases, humidity sensors can measure moisture levels, which can provide data that can be used to predict the likelihood of icing. In some examples, capacitive or resistive sensors can detect changes in the electrical properties on the surface of the radome that may be indicative of ice. In addition, a vehicle may use other types of sensors, such as cameras or infrared sensors, to visually identify ice in the environment or specifically on the radome.

At block 704, method 700 involves adjusting a temperature of the frequency selective structure based on determining the increase in the likelihood of ice on the radome. For instance, the computing system may increase the temperature of the frequency selective structure to melt ice from the radome. In some cases, the computing system may increase the temperature of the frequency selective structure when the likelihood of ice increases above a predefined threshold. The computing system may also increase the frequency selective structure's temperature to check if the increased temperature improves the radiation pattern or signal strength of return signals. The computing system may monitor the resonant frequencies of the frequency selective structure to determine whether increasing the temperature of the frequency selective structure causes the resonant frequencies to return back to optimal range.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A radar system comprising:
a frequency selective structure positioned in front of a radiating surface having one or more antennas, wherein the frequency selective structure comprises arrays of micro-wires forming a plurality of intersections and one or more patches positioned at one or more intersections of the plurality of intersections,
wherein at least one patch of the one or more patches is positioned with an offset relative to a corresponding intersection, and
wherein the frequency selective structure has a rotational angle with respect to an antenna polarization of the one or more antennas.

2. The radar system of claim 1, wherein a spacing between the micro-wires of the frequency selective structure is configured to optimize a desired band-pass for specific performance by the one or more antennas.

3. The radar system of claim 1, wherein the arrays of micro-wires comprises a first set of metal traces aligned in parallel at a positive slant angle and a second set of metal traces aligned in parallel at a negative slant angle.

4. The radar system of claim 1, wherein the frequency selective structure is coupled to a surface of a radome.

5. The radar system of claim 4, wherein the frequency selective structure includes a super hydrophobic feature, a heating element, or a cosmetic feature.

6. The radar system of claim 4, wherein the frequency selective structure is coupled to a current source and configured to increase in temperature when current is received from the current source.

7. The radar system of claim 6, further comprising:
a computing device coupled to the current source, wherein the computing device is configured to:
determine that precipitation is in an environment of the radar system; and
cause the current source to supply current to the frequency selective structure based on determining that precipitation is in the environment of the radar system.

8. The radar system of claim 1, wherein the frequency selective structure further comprises low pass filter (LPF) structures and high pass filter (HPF) structures, wherein the LPF structures correspond to portions of the micro-wires located across a field of view of the one or more antennas and the HPF structures correspond to the one or more patches.

9. The radar system of claim 1, wherein at least one path of the one or more patches is located on a micro-wire at a threshold distance from the plurality of intersections.

10. The radar system of claim 1, wherein the one or more patches comprises:
at least a first patch having a first polygonal shape and a second patch having a second polygonal shape, wherein the first polygonal shape differs from the second polygonal shape.

11. The radar system of claim 10, wherein the first polygonal shape is a circular shape and the second polygonal shape is a non-circular shape.

12. The radar system of claim 1, wherein positions of the one or more patches within the frequency selective structure is based on a plurality of simulations.

13. The radar system of claim 1, wherein the one or more patches are circular and uniform in size.

14. The radar system of claim 1, wherein the frequency selective structure is composed of a semiconductor material.

15. The radar system of claim 1, wherein the frequency selective structure is composed of a material selected from the group consisting of metal, alloy, and dielectric.

16. A system comprising:
a frequency selective structure coupled to a radome and configured to optimize a desired band-pass for specific performance by one or more antennas, wherein the frequency selective structure comprises arrays of micro-wires forming a plurality of intersections and one or more patches positioned at one or more intersections of the plurality of intersections,
wherein at least one patch of the one or more patches is positioned with an offset relative to a corresponding intersection, and
wherein the frequency selective structure has a rotational angle with respect to an antenna polarization of the one or more antennas.

17. The system of claim 16, wherein the frequency selective structure is configured to melt snow or rain off the radome when current is applied to the frequency selective structure.

18. The system of claim 16, wherein the at least one patch is positioned with the offset relative to a center of the corresponding intersection, and
wherein a degree of the rotational angle is based on a plurality of signal transmission simulations.

19. The system of claim 16, further comprising:
a computing device configured to:
detect a change in resonance of a circuit comprising the frequency selective structure; and
adjust a voltage of the circuit comprising the frequency selective structure based on detecting the change in resonance of the circuit, wherein adjusting the voltage changes a temperature of the frequency selective structure.

20. A method comprising:
forming a frequency selective structure configured to optimize a desired band-pass for specific performance by one or more antennas, wherein the frequency selective structure comprises arrays of micro-wires forming a plurality of intersections and one or more patches positioned at one or more intersections of the plurality of intersections, wherein at least one patch of the one or more patches is positioned with an offset relative to a corresponding intersection, and wherein the frequency selective structure has a rotational angle with respect to an antenna polarization of the one or more antennas; and
coupling the frequency selective structure to a radome such that the frequency selective structure is positioned in front of a radiating surface having the one or more antennas.
